(19) United States
(12) Patent Application Publication
(10) Pub. No.: US 2023/0086642 A1
(43) Pub. Date: Mar. 23, 2023

(54) VOICE CONVERSION DEVICE, VOICE CONVERSION METHOD, AND VOICE CONVERSION PROGRAM

(71) Applicant: The University of Tokyo, Tokyo (JP)

(72) Inventors: Shinnosuke Takamichi, Tokyo (JP); Yuki Saito, Tokyo (JP); Takaaki Saeki, Tokyo (JP); Hiroshi Saruwatari, Tokyo (JP)

(21) Appl. No.: 17/798,857

(22) PCT Filed: Feb. 5, 2021
(86) PCT No.: PCT/JP2021/004367

§ 371 Date: Oct. 28, 2022

(30) Foreign Application Priority Data
Feb. 13, 2020 (JP) 2020-022334

(51) Int. Cl. G10L 13/033; G10L 25/18; G10L 25/30; G10L 13/047

(52) U.S. Cl. CPC G10L 13/033; G10L 25/18; G10L 25/30; G10L 13/047

(57) ABSTRACT

The present invention provides a voice conversion apparatus and the like using a differential spectral method which is capable of implementing both high voice quality and real-time performance even in wideband. A voice conversion apparatus 10 includes: an acquiring unit 11 configured to acquire a signal of a voice of a subject; a dividing unit 12 configured to divide the signal into sub-band signals corresponding to a plurality of frequency bands; a converting unit configured to convert one or a plurality of sub-band signals corresponding to one or a plurality of lower frequency bands, out of the sub-band signals corresponding to the plurality of frequency bands; and a synthesizing unit 16 configured to generate a synthesized voice by synthesizing the one or plurality of sub-band signals after conversion and the remaining sub-band signals that are not converted.

### CROSS REFERENCE TO RELATED APPLICATION

This application claims the benefit of Japanese Patent Application No. 2020-022334, filed on Feb. 13, 2020, which is hereby incorporated by reference.

### TECHNICAL FIELD

The present invention relates to a voice conversion apparatus, a voice conversion method and a voice conversion program.

### BACKGROUND ART

Research on converting a voice of a subject and generating a synthesized voice as if a different person were speaking have been ongoing. For example, the following Non-Patent Document 1 describes a technique to estimate a filter, which corresponds to a difference between an envelope spectral component of a subject (conversion source) and an envelope spectral component of a speaker (conversion destination), and to apply this filter to the voice of the subject so as to generate a synthesized voice of the conversion destination. (This technique is also called “differential spectrum method”.)

In the voice quality conversion based on the differential spectrum method, it is known that the converted voice, of which quality is higher than the conventional mel-log spectrum approximation (MLSA), can be acquired by using a minimum phase filter, as described in the following Non-Patent Document 2.

Furthermore, in the voice quality conversion based on the differential spectrum method, the following Non-Patent Document 3 describes a method of preventing deterioration of the quality of the synthesized voice while suppressing the calculation volume required for calculating the filter. Specifically, the Non-Patent Document 3 describes that under the condition that the filter is limited to a fixed tap length, a lifter of a Hilbert transform that is performed on a real cepstrum is learned from voice data, so as to minimize an estimation error of the real cepstrum.

### CITATION LIST

### Non-Patent Document

Non-Patent Document 1: Kazuhiro Kobayashi, Tomoki Toda and Satoshi Nakamura, “Intra-gender statistical singing voice conversion with direct waveform modification using log-spectral differential”, Speech Communication, volume 99, May 2018, pages 211-220.
Non-Patent Document 2: Hitoshi Suda, Gaku Kotani, Shinnosuke Takamichi, and Daisuke Saito, “A Revisit to Feature Handling for High-quality Voice Conversion”, Proceedings, APSIPA Annual Summit and Conference November 2018, pages 816-822.
Non-Patent Document 3: Takaaki Saeki, Yuki Saito, Shinnosuke Takamichi, Hiroshi Saruwatari: “Filter estimation for reducing calculation volume of DNN voice quality conversion based on differential spectrum method”, Reports of Autumn Meeting of Acoustic Society of Japan, Number 2-4-1, Shiga, September 2019

### SUMMARY OF INVENTION

### Technical Problem

Generally it is preferable to expand a target band of voice quality conversion to improve voice quality. However, if the above mentioned differential spectrum method is directly applied to the wideband (e.g. 48 kHz) sampling voice conversion, modeling performance may drop due to the random fluctuation in the higher frequency band in the wideband, that is, the quality of the converted voice may not improve much regardless the expansion of the target band of voice quality conversion. Further, the expansion of the band may increase the calculation volume required for filtering, which may affect real-time performance.

With the foregoing in view, the present invention provides a voice conversion apparatus, a voice conversion method, and a voice conversion program based on the differential spectrum method, which is capable of implementing both high voice quality and real-time performance in the wideband voice quality conversion.

### Solution to Problem

A voice conversion apparatus according to an aspect of the present invention includes: an acquiring unit configured to acquire a signal of a voice of a subject; a dividing unit configured to divide the signal into sub-band signals corresponding to a plurality of frequency bands; a converting unit configured to convert one or a plurality of sub-band signals corresponding to one or a plurality of lower frequency bands, out of the sub-band signals corresponding to the plurality of frequency bands; and a synthesizing unit configured to generate a synthesized voice by synthesizing the one or plurality of sub-band signals after conversion and a remaining sub-band signal that is not converted.

According to this aspect, only the one or plurality of sub-band signals corresponding to the one or plurality of lower frequency bands, out of the plurality of sub-band signals generated by dividing the voice of the subject, are converted, whereby the influence of random fluctuation in the higher frequency band can be decreased, and the calculation volume due to the conversion can be decreased. Therefore even in wideband, the voice conversion based on the differential spectrum method, which is capable of implementing both high voice quality and real-time performance, can be performed.

In the above aspect, a sampling frequency of the signal is 44.1 kHz or more, and the one or plurality of sub-band signals corresponding to the one or plurality of lower frequency bands may include at least sub-band signals corresponding to 2 kHz to 4 kHz frequency bands.

According to this aspect, 2 to 4 kHz, where individuality normally appears in the voice conversion, is considered, hence voice quality can be improved.

In the above aspect, the converting unit may further include: a filter calculating unit configured to calculate a spectrum of a filter by converting a feature value indicating a tone of voice of the one or plurality of sub-band signals corresponding to the one or plurality of lower frequency bands using a learned conversion model, and multiplying the feature value after conversion by a learned lifter; a shortened filter calculating unit configured to calculate a shortened filter by performing inverse Fourier transform on the spectrum of the filter, and applying a predetermined window function thereto; and a generating unit configured to generate a converted voice of the one or plurality of sub-band signals corresponding to the one or plurality of lower frequency bands by multiplying the spectrum of the signal by the spectrum determined by performing Fourier transform on the shortened filter, and performing inverse transform thereon.

According to this aspect, not only converting the feature value using the learned conversion model, but the shortened filter is also calculated using the learned lifter, therefore voice conversion based on the differential spectrum method, which is capable of implementing both high voice quality and real-time performance, can be performed.

In the above aspect, the voice conversion apparatus may further include a learning unit configured to calculate a feature value indicating a tone of the converted voice by multiplying the spectrum of the one or plurality of sub-band signals corresponding to the one or plurality of lower frequency bands by the spectrum determined by performing Fourier transform on the shortened filter, updating a parameter of the conversion model and the lifter so as to minimize an error between the feature value and a feature value indicating a tone of a target voice, and generating the learned conversion model and the learned lifter.

According to this aspect, the learned conversion model and the learned lifter are generated, whereby the influence of cutting the filter to generate the shortened filter is suppressed, and high quality voice conversion can be performed even with the shortened filter.

The conversion model may be constructed by a neural network, and the learning unit may update the parameter by an error back propagation method, and generate the learned conversion model and the learned lifter.

A voice conversion method according to an aspect of the present invention executed by a processor included in a voice conversion apparatus includes steps of: acquiring a signal of a voice of a subject; dividing the signal into sub-band signals corresponding to a plurality of frequency bands; converting one or a plurality of sub-band signals corresponding to one or a plurality of lower frequency bands, out of the sub-band signals corresponding to the plurality of frequency bands; and generating a synthesized voice by synthesizing the one or plurality of sub-band signals after the conversion and a remaining sub-band signal that is not converted.

A voice conversion program according to an aspect of the present invention causes a processor included in the voice conversion apparatus to function as: an acquiring unit configured to acquire a signal of a voice of a subject; a dividing unit configured to divide the signal into sub-band signals corresponding to a plurality of frequency bands; a converting unit configured to convert one or a plurality of sub-band signals corresponding to one or a plurality of lower frequency bands, out of the sub-band signals corresponding to the plurality of frequency bands; and a synthesizing unit configured to generate a synthesized voice by synthesizing the one or plurality of sub-band signals after conversion and a remaining sub-band signal that is not converted.

### Advantageous Effects of Invention

According to the present invention, a voice conversion apparatus, a voice conversion method, and a voice conversion program based on the differential spectrum method, which is capable of implementing both high voice quality and real-time performance in the wideband voice quality conversion, can be provided.

### BRIEF DESCRIPTION OF DRAWINGS

FIG. 1 is a diagram depicting functional blocks of a voice conversion apparatus according to an embodiment of the present invention.

FIG. 2 is a diagram depicting a physical configuration of the voice conversion apparatus according to the present embodiment.

FIG. 3 is a conceptual diagram depicting a voice quality conversion using a sub-band signal, which is executed by the voice conversion apparatus according to the present embodiment.

FIG. 4 is a diagram depicting an overview of the conversion of a LOWER FREQUENCY SUB-BAND SIGNAL and learning processing, which is executed by the voice conversion apparatus 10 according to the present embodiment.

FIG. 5A indicates a result of subjective evaluation on speaker similarity of the synthesized voice generated by the voice conversion apparatus according to the present embodiment and by a conventional method respectively.

FIG. 5B indicates a result of subjective evaluation on voice quality of the synthesized voice generated by the voice conversion apparatus according to the present embodiment and by a conventional method respectively.

FIG. 6 is a flow chart of the voice conversion processing executed by the voice conversion apparatus according to the present embodiment.

FIG. 7 is a flow chart of the learning processing executed by the voice conversion apparatus according to the present embodiment.

### DESCRIPTION OF EMBODIMENTS

Embodiments of the present invention will be described with reference to the accompanying drawings. In each drawing, composing elements denoted with a same reference signa has an identical or similar configuration.

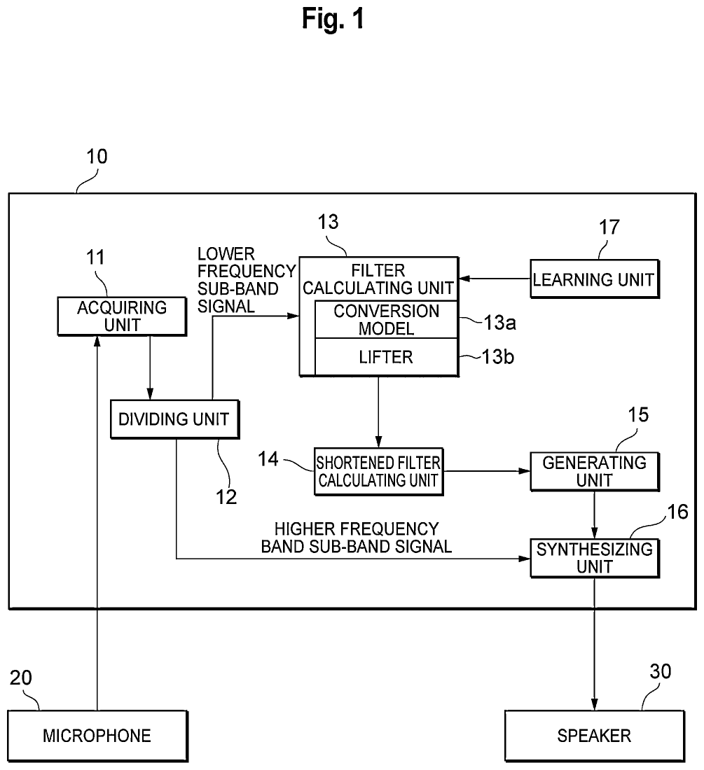

FIG. 1 is a diagram depicting functional blocks of a voice conversion apparatus 10 according to an embodiment of the present invention. The voice conversion apparatus 10 includes an acquiring unit 11, a dividing unit 12, a filter calculating unit 13, a shortened filter calculating unit 14, a generating unit 15, a synthesizing unit 16 and a learning unit 17.

The acquiring unit 11 acquires a signal of a voice of a subject. The acquiring unit 11 acquires the voice of the subject, which has been converted into an electric signal by a microphone 20, for a predetermined period.

The dividing unit 12 divides a signal of a voice in a single frequency band (also called “full band signal” or “wide band signal”) acquired by the acquiring unit 11 into sub-band signals corresponding to a plurality of frequency bands. Specifically, the dividing unit 12 divides a band of the voice of the conversion source speaker by the sub-band multi-rate processing.

The dividing unit 12 divides a band of the voice of the subject into N number of sub-band signals, modulates each of the N number of sub-band signals to generate base band signals of N number of sub-bands, and shifts frequency. For example, as indicated in the following Expression (1), the dividing unit 12 may generate a base band signal xₙ(t) of the n-th sub-band, from the signal x(t) of the voice of the subject in the t (1≤t≤T) th frame, out of the total number of frames T in a predetermined period.

xₙ(t)=x(t)W_{N}^{-t(n-1/2)} Expression (1)

Here n=1, 2, . . . , N, and W_{N}=exp(j2π/2N), for example.

The dividing unit 12 may limit the base band signal xₙ(t), which is a base band signal of the n-th sub-band, to a predetermined band (e.g. [−π/2N, π/2N]) by applying a low pass filter f(t), which is common to the full band (that is, common to the N number of sub-bands). For example, a signal of which band of the base band signal xₙ(t) of the n-th sub-band is limited to a predetermined band is given by the following Expression (2).

x_{n,pp}(t)=f(t)*xₙ(t) Expression (2)

Here * is a convolution operator. The signal x_{n,pp}(t) is acquired as a complex value.

The dividing unit 12 also converts the signal x_{n,pp}(t), which is acquired as the complex value, into a real value x_{n,SSB}(t). For example, the dividing unit 12 may acquire the real value x_{n,SSB}(t) by the following Expression (3) using the single sideband (SSB) modulation method.

x_{n,SSB}(t)=x_{n,pp}(t)W_{N}^{t/2}+x_{n,pp}*(t)W_{N}^{-t/2} Expression (3)

Here ⋅* indicates a complex conjugate.

The dividing unit 12 also generates the n-th sub-band signal xₙ(k) by decimating the real value x_{n,SSB}(t) at a decimation rate M. The n-th sub-band signal xₙ(k) is given by the following Expression (4), for example.

xₙ(k)=x_{n,SSB}(kM) Expression (4)

Out of the N number of sub-band signals generated by the dividing unit 12, one or a plurality of sub-band signals corresponding to one or a plurality of low frequency bands are called “lower frequency sub-band signals”, and one or a plurality of sub-band signals corresponding to one or a plurality of higher frequency bands, other than the lower frequency sub-band signals, are called “higher frequency sub-band signals”. The lower frequency sub-band signals may also be called a “sub-band signal in a low frequency band”, a “low band sub-band signal”, a “low frequency sub-band signal” or the like. In the same manner, the higher frequency sub-band signals may also be called a “sub-band signal in a high frequency band”, a “high band sub-band signal”, a “high frequency band sub-band signal” or the like.

The filter calculating unit 13 converts the feature value, which expresses the tone of voice, of the lower frequency sub-band signals using a learned conversion model 13a, and multiplies the feature value after the conversion by a learned lifter 13b, so as to calculate a spectrum of a filter (also called “differential filter”). Here the feature value that expresses the tone of voice may be a mel-frequency cepstrum of the voice. By using the mel-frequency cepstrum for the feature value, the tone of voice of the subject can be appropriately captured.

The filter calculating unit 13 calculates a real cepstrum series Cₜ^{(X)} in low order (e.g. 10 to 100 degrees) from the complex spectral series Fₜ^{(X)} determined by performing Fourier transform on the lower frequency sub-band signals in the t (1≤t≤T) th frame in a predetermined period. Then the filter calculating unit 13 converts the real cepstrum series COQ using the learned conversion model 13a, so as to calculate the feature value after conversion CP.

Further, the filter calculating unit 13 multiplies the feature value after conversion Cₜ^{(D)} by the learned lifter 13b, so as to calculate a spectrum of the filter. Specifically, the filter calculating unit 13 calculates a product uCₜ^{(D)} (where u is the learned lifter 13b), and performs inverse Fourier transform thereon, so as to determine an exponential function (exp), whereby the complex spectral series Fₜ^{(D)} of the filter is calculated.

The value of the learned lifter 13b used by the voice conversion apparatus 10 according to the present embodiment is a value determined by a later mentioned learning processing. In the learning processing, the value of the lifter 13b is updated along with the parameters of the conversion model 13a, and is determined such that the target voice is better reproduced by the synthesized voice.

The shortened filter calculating unit 14 performs inverse Fourier transform on the complex spectral series Fₜ^{(D)} of the filter, and applies a predetermined window function thereto, so as to calculate the shortened filter. Specifically, the shortened filter calculating unit 14 performs inverse Fourier transform on the complex spectral series Fₜ^{(D)} of the filter, so as to determine a value fₜ^{(D)} in a time domain (also called a “differential filter” in the time domain). For example, as indicated in Expression (5), the shortened filter calculating unit 14 calculates the complex spectral series Fₜ^{(l)} of the shortened filter of which tap length is l, by cutting the value fₜ^{(D)} with applying the window function w, so that the value fₜ^{(D)} becomes 1 before the time l, and becomes 0 after the time l, and performing Fourier transform thereon.

$${f}_{t}^{( l )} = {f}_{t}^{( D )} \cdot w , \\ w = {[ {1}^{0 th} , … , {1}^{( l - 1 ) th} , {0}^{lth} , … , {0}^{( N - 1 ) th} ]}^{⊤} \qquad Expression ( 5 )$$

In Expression (5), N denotes the number of frequency pins, T denotes a total number of frames in a predetermined period, and l denotes a tap length (l-th frame).

The generating unit 15 multiplies the spectrum of the lower frequency band sub-band signal by the spectrum generated by performing Fourier transform on the shortened filter, and performs inverse Fourier transform thereon, so as to generate a converted voice. The generating unit 15 calculates a product Fₜ^{(Y)} of the spectrum Fₜ^{(l)} generated by performing Fourier transform on the shortened filter and the spectrum Fₜ^{(X)} of the lower frequency band sub-band signal, and performs inverse Fourier transform on the spectrum Fₜ^{(Y)}, to as to generate the converted voice of the lower frequency band sub-band signal. The filter calculating unit 13, the shortened filter calculating unit 14 and the generating unit 15 may be called a “converting unit”.

The synthesizing unit 16 synthesizes: the signals of the converted voice of the lower frequency sub-band signals generated by the generating unit 15 (that is, sub-band signals after conversion); and the higher frequency sub-band signals separated by the dividing unit 12 (that is, the remaining sub-band signals that are not converted).

The synthesizing unit 16 upsamples the n (1≤n≤N) th sub-band signals Xₙ(t) at the decimation rate M, for example, as indicated in Expression (6), and acquires the real value X_{n,SSB}(t) of the converted voice signal. The n-th sub-band signal Xₙ(t) is a signal of the converted voice after converting the lower frequency band sub-band signal xₙ(k) generated by the dividing unit 12, or a same signal as the higher frequency band sub-band signal xₙ(k) generated by the dividing unit 12 (unconverted signal). For example, in the case of assigning an index n to the plurality of sub-bands in the full band in ascending order from the lower frequency band, the sub-band signal X₁(t) of the sub-band of a predetermined number (e.g. 1) from n=1 is a signal of the converted voice after the lower frequency band sub-band signal x₁(k) is converted. On the other hand, the sub-band signals X₂(t), X₃(t), . . . , X_{N}(t) of n=2, 3, . . . , N may be the same signals as the higher frequency sub-band signals x₂(k), x₃(k), . . . , x_{N}(k) (unconverted signals).

$${X}_{n , SSB} ( t ) = \{ \begin{matrix}{X}_{n} ( t / M ) & ( t = 0 , M , 2 M , … ) \\ 0 & ( otherwise )\end{matrix} \qquad Expression ( 6 )$$

Further, in order to avoid aliasing, the synthesizing unit 16 frequency-shifts the real value X_{n,SSB}(t) to the base band, limits the band using the low pass filter g(t), and acquires the complex value X_{n,pp}(t), for example, as indicated in Expression (7).

X_{n,pp}(t)=g(t)*(X_{n,SSB}(t)W_{N}^{-t/2}) Expression (7)

Furthermore, the synthesizing unit 16 acquires the converted voice X(t) in full band, for example, as indicated in Expression (8).

$$X ( t ) = {\sum }_{n = 1}^{N} \{ {X}_{n , pp} ( t ) {W}_{N}^{t ( n - 1 / 2 )} + {X}_{n , pp}^{*} ( t ) {W}_{N}^{- t ( n - 1 / 2 )} \} \qquad Expression ( 8 )$$

The learning unit 17 calculates the feature value expressing the tone of the converted voice by multiplying the spectrum of the lower frequency band sub-band signal by the spectrum determined by performing Fourier transform on the shortened filter, updates the parameters of the conversion model and the lifter so as to minimize error between this feature value and the feature value expressing the tone of the target voice, and generates the learned conversion model and the learned lifter thereby. In the present embodiment, the conversion model 13a is constructed by a neural network. For example, the conversion model 13a may be constructed by a multi-layer perceptron (MLP) and a feedforward neural network, and may use a gated linear unit constituted of a Sigmoid function and a tanh function as the activation functions of a hidden layer, and apply batch normalization before each activation function.

The learning unit 17 calculates the spectrum Ft^{(l)} generated by performing Fourier transform on the shortened filter, using the conversion model 13a and the lifter 13b of which parameters are not determined, calculates the spectrum Fₜ^{(Y)} by multiplying the spectrum Fₜ^{(X)} of the lower frequency band sub-band signal by the spectrum Fₜ^{(l)}, and calculates the mel-frequency cepstrum Cₜ^{(Y)} as the feature value. Then the learning unit 17 calculates the error between the calculated cepstrum Cₜ^{(Y)} and the cepstrum Cₜ^{(T)} of the target voice, which is learning data, by Lₜ=Cₜ^{(T)}−Cₜ^{(Y)})^{T}(Cₜ^{(T)}−Cₜ^{(Y)})/T. Hereafter the value of √L is called rooted mean squared error (RMSE).

The learning unit 17 performs partial differentiation on the error Lₜ=(Cₜ^{(T)}−Cₜ^{(Y)})^{T}(Cₜ^{(T)}−C^{t}_{(Y)})/T using the parameters of the conversion model and the lifter, and updates the parameters of the conversion model and the lifter by the error back propagation method. The learning processing may be performed using the adaptive moment estimation (Adam), for example. By generating the learned conversion model 13a and the learned lifter 13b like this, the influence of cutting the filter to generate the shortened filter is suppressed, and high quality voice conversion can be performed even with a shortened filter.

According to the voice conversion apparatus 10 according to the present embodiment, for lower frequency sub-band signals generated by dividing a signal of a voice of a subject into a plurality of sub-band signals, the feature value is converted using the learned conversion model 13a, and the shortened filter is calculated using the learned lifter 13b. Therefore even for wideband voice quality conversion, a drop in the modeling performance due to the random fluctuation in the higher frequency band can be prevented, and the effect of improving the quality of the converted voice by band expansion can be properly acquired. Further, an increase in the calculation volume caused by band expansion can be lessened by learning the lifter 13b only for the lower frequency sub-band signals. Therefore the voice conversion based on the differential spectrum method, which is capable of implementing both high voice quality and real-time performance, can be performed in the wideband voice quality conversion.

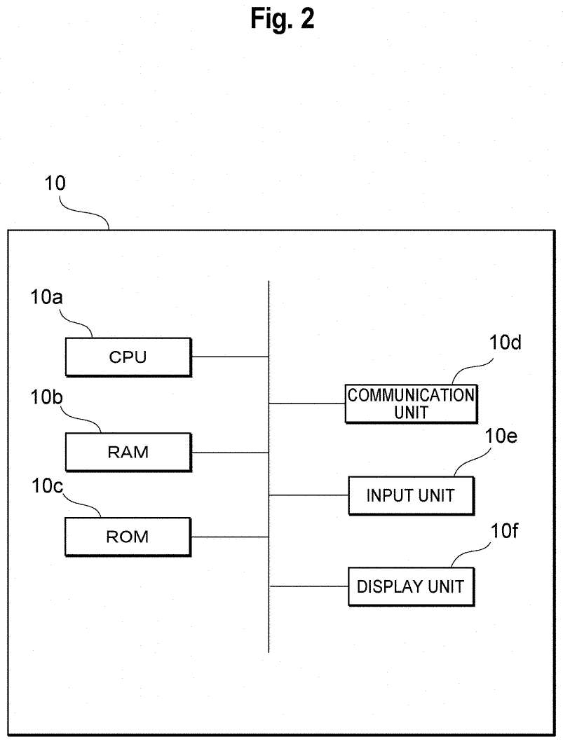

FIG. 2 is a diagram depicting a physical configuration of the voice conversion apparatus 10 according to the present embodiment. The voice conversion apparatus 10 includes a central processing unit (CPU) 10a which corresponds to an arithmetic unit, a random access memory (RAM) 10b which corresponds to a storage unit, a read only memory (ROM) 10c which corresponds to a storage unit, a communication unit 10d, an input unit 10e and a display unit 10f. Each of these composing elements is connected via a bus, so that data transmission/reception can be performed with each other. In the present example, a case of the voice conversion apparatus 10 constituting of one computer will be described, but the voice conversion apparatus 10 may be constituted of a combination of a plurality of computers. The configuration indicated in FIG. 2 is an example, and the voice conversion apparatus 10 may include composing elements other than these composing elements, or may not include part of these composing elements.

The CPU 10a is a control unit that performs control in executing programs stored in the RAM 10b or ROM 10c, and performs the arithmetic operation and processing of data. The CPU 10a is also an arithmetic unit to execute programs (voice conversion program) that calculate a plurality of feature values related to the voice of the subject, converts these plurality of feature values into a plurality of converted feature values corresponding to the target voice, and generates synthesized voice based on the plurality of converted feature values. The CPU 10a receives various data from the input unit 10e and the communication unit 10d, and displays the arithmetic operation result of the data on the display unit 10f, or stores the result in RAM 10b.

The RAM 10b is a storage unit in which data can be overwritten, and may be a semiconductor storage element, for example. The RAM 10b may store programs executed by the CPU 10a and such data as voice of the subject and the target voice. These are examples, and data other than these data may be stored in RAM 10b, or part of these data may not be stored therein.

The ROM 10c is a storage device from which data can be read, and may be constituted of a semiconductor storage element, for example. The ROM 10c may store a voice conversion program and data that cannot be overwritten.

The communication unit 10d is an interface to connect the voice conversion apparatus 10 to another apparatus. The communication unit 10d may be connected to a communication network, such as the Internet.

The input unit 10e is for receiving data inputted by the user, and may include a keyboard and a touch panel, for example.

The display unit 10f is for visually displaying an operation result by the CPU 10a, and may be constructed by a liquid crystal display (LCD). The display unit 10f may display a waveform of the voice of the subject, or display a waveform of a synthesized voice.

The voice conversion program may be stored in and provided via a computer-readable storage medium, such as the RAM 10b and ROM 10c, or may be provided via a computer network connected to the communication unit 10d. In the voice conversion apparatus 10, various operations, described with reference to FIG. 1, are implemented by the CPU 10a executing the voice conversion program. This physical configuration is an example, and need not always be an independent configuration. For example, the voice conversion apparatus 10 may include large scale integration (LSI), in which the CPU 10a, the RAM 10b and the ROM 10c are integrated.

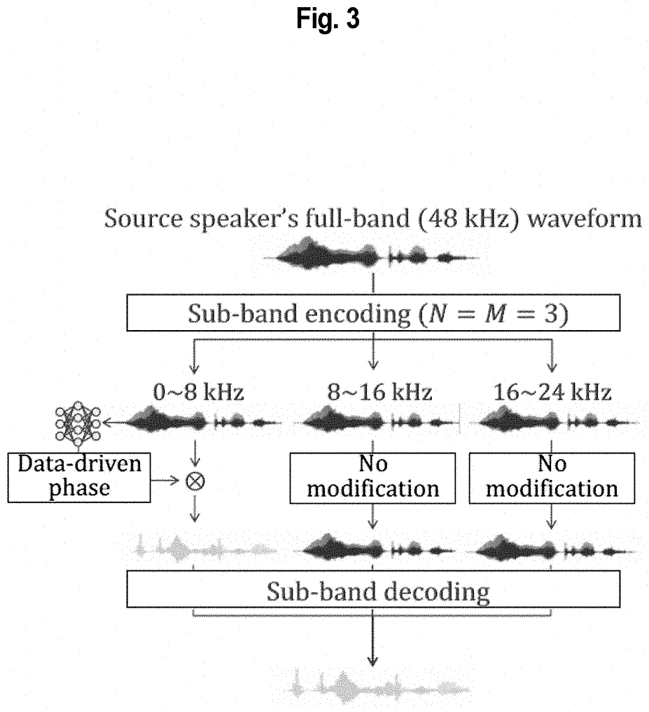

FIG. 3 is a conceptual diagram of voice quality conversion using a sub-band signal that is executed by the voice conversion apparatus 10 according to the present embodiment. FIG. 3 indicates an example where the target band of the voice quality conversion (also called “sampling frequency”) is 48 kHz, a number of sub-bands N=3, and the decimation rate M=3, but the present invention is not limited thereto.

As indicated in FIG. 3, the dividing unit 12 of the voice conversion apparatus 10 generates three sub-band signals (0 to 8 kHz, 8 to 16 kHz and 16 to 24 kHz) from a full band signal of the voice of the subject (signal of voice of 48 kHz in this example). (This process is called “sub-band encoding”.)

The generating unit 15 of the voice conversion apparatus 10 applies a shortened filter, calculated by the shortened filter calculating unit 14, to the spectrum of the lower frequency band sub-band signal (0 to 8 kHz), out of the three sub-band signals generated by the dividing unit 12, so as to generate a converted voice. The voice conversion apparatus 10, on the other hand, does not use the shortened filter for the two higher frequency sub-band signals (8 to 16 kHz, 16 to 24 kHz), and leaves these signals unconverted.

The synthesizing unit 16 of the voice conversion apparatus 10 resynthesizes the converted voice of the lower frequency band sub-band signal (0 to 8 kHz) and two unconverted higher frequency sub-band signals (8 to 16 kHz and 16 to 24 kHz), so as to generate a full band synthesized voice. The synthesizing unit 16 outputs the generated synthesized voice (sub-band decoding).

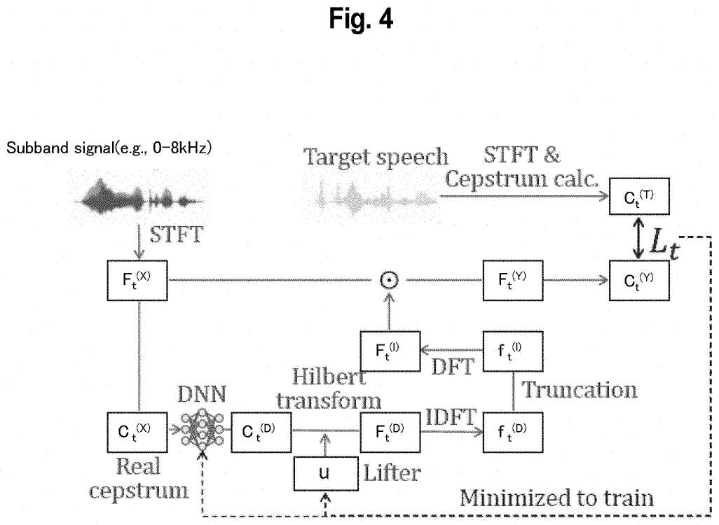

FIG. 4 is a diagram depicting an overview of the conversion of a lower frequency band sub-band signal and learning processing, executed by the voice conversion apparatus 10 according to the present embodiment. The voice conversion apparatus 10 divides a full band signal of the voice of the subject into a plurality of sub-band signals, acquires a lower frequency band sub-band signal (e.g. 0 to 8 kHz sub-band signal in FIG. 3) from the plurality of sub-band signals, and calculates the Fourier transformed complex spectral series Fₜ^{(X)}. Then the voice conversion apparatus 10 calculates a real cepstrum series Cₜ^{(X)} from the complex spectral series Fₜ^{(X)}, and inputs the calculated real cepstrum in Cₜ^{(X)} to a learned conversion model 13a. In FIG. 4, the conversion model 13a is expressed by the schematic diagram of the neural network.

The voice conversion apparatus 10 multiplies the converted feature value Cₜ^{(D)} by a learned lifter 13b (u), and performs Fourier transform thereon, so as to calculate the complex spectral series Fₜ^{(D)} of the filter.

Then as a value fₜ^{(D)} in the time domain determined by performing inverse Fourier transform on the complex spectral series Fₜ^{(D)} of the filter, the voice conversion apparatus 10 performs Fourier transform on fₜ^{(l)} determined by applying a window function, which cuts off (perform truncation) so that the value fₜ^{(D)} becomes 1 before the time l and becomes 0 after the time l, whereby the complex spectral series Fₜ^{(l)} of the shortened filter.

The voice conversion apparatus 10 multiplies the spectrum Fₜ^{(X)} of the lower frequency band sub-band signal by the complex spectral series Fₜ^{(l)} of the shortened filter calculated like this, so as to calculate the spectrum Fₜ^{(Y)} of the converted voice. The voice conversion apparatus 10 generates the converted voice Cₜ^{(Y)} by performing inverse Fourier transform on the spectrum Fₜ^{(Y)} of the converted voice.

In the case of performing the learning processing of the conversion model 13a and the lifter 13b, the real cepstrum series Cₜ^{(Y)} is calculated from the spectrum Fₜ^{(Y)} of the converted voice, and errors from the cepstrum Cₜ(T) of the target voice, which is learning data, is calculated by Lₜ=(Cₜ^{(T)}−Cₜ^{(Y)})^{T}(Cₜ^{(T)}−Cₜ^{(Y)})/T. Then the parameters of the conversion model 13a and the lifter 13b are updated by an error back propagation method.

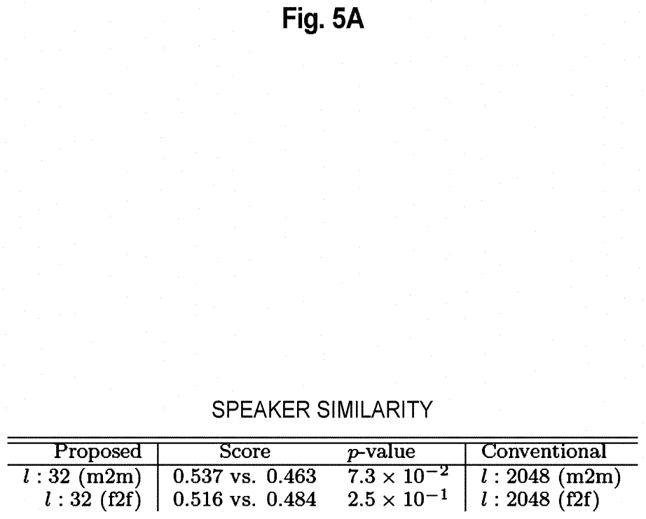

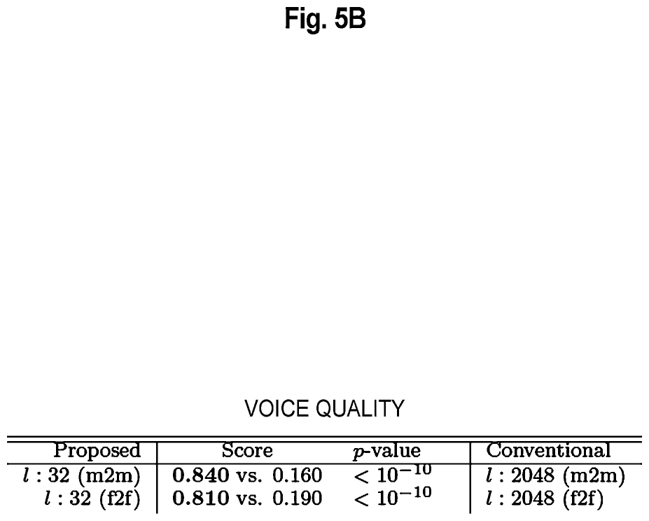

FIG. 5A is a result of subjective evaluation of the speaker similarity of synthesized voices generated by the voice conversion apparatus 10 according to the present embodiment and an apparatus according to a conventional method respectively. The result of the subjective evaluation on speaker similarity is a result when a plurality of testers compared: a synthesized voice generated by the voice conversion apparatus 10 according to the present embodiment; a synthesized voice generated by an apparatus according to a conventional method; and a target voice (correct voice), and evaluated which voice of the present embodiment and the conventional method is similar to the target voice.

In FIG. 5A, the evaluation values (scores) in a case of using the tap length l=32 (present embodiment) and the tap length l=2048 (conventional method) are indicated in the form of “score of present embodiment vs score of conventional method”. It is assumed that in the conventional method, a minimum phase filter is used, and in the present embodiment, the shortened filter, calculated by the conversion model 13a and the lifter 13b learned using the lower frequency band sub-band signal, is used. Here a 48 kHz sampling voice is used for two types of conversion (a male speaker to male speaker (m2m), and a female speaker to female speaker (f2f)).

As indicated in FIG. 5A, in the case where the tap length l is 32 (present embodiment) and the case where the tap length l is 2048 (conventional method), the score of the speaker similarity of the present embodiment in m2m is 0.537, while the score of the speaker similarity of the conventional method in m2m is 0.463. In the same manner, the score of the speaker similarity of the present embodiment in f2f is 0.516, while the score of the speaker similarity of the conventional method in f2f is 0.484.

In FIG. 5A, the tap length l of the present embodiment (=32) is 1/64 times the tap length l of the conventional method (=2048), hence the calculation volume of the voice conversion apparatus 10 can be decreased by shortening the filter. The score of the speaker similarity can also be further improved than the conventional method, as mentioned above.

FIG. 5B is a result of subjective evaluation on the voice quality of the synthesized voices generated by the voice conversion apparatus 10 according to the present embodiment and an apparatus according to a conventional method respectively. The result of the subjective evaluation on the voice quality is a result when a plurality of testers compared: a synthesized voice generated by the voice conversion apparatus 10 according to the present embodiment; and a synthesized voice generated by the apparatus according to the conventional method, and evaluated which voice of the present embodiment and the conventional method sounds like a natural voice. The preconditions in FIG. 5B are the same as those of FIG. 5A.

As indicated in FIG. 5B, in the case where the tap length l is 32 (present embodiment) and the case where the tap length l is 2048 (conventional method), the score of the speaker similarity of the present embodiment in m2m is 0.840, while the score of the speaker similarity of the conventional method in m2m is 0.160. In the same manner, the score of the speaker similarity of the present embodiment in f2f is 0.810, while the score of the speaker similarity of the conventional method in f2f is 0.190.

In this way, it is evaluated that the synthesized voice generated by the voice conversion apparatus 10 according to the present embodiment sounds more natural than the synthesized voice generated by an apparatus according to the conventional method. The p value related to this evaluation is smaller than 10⁻¹⁰.

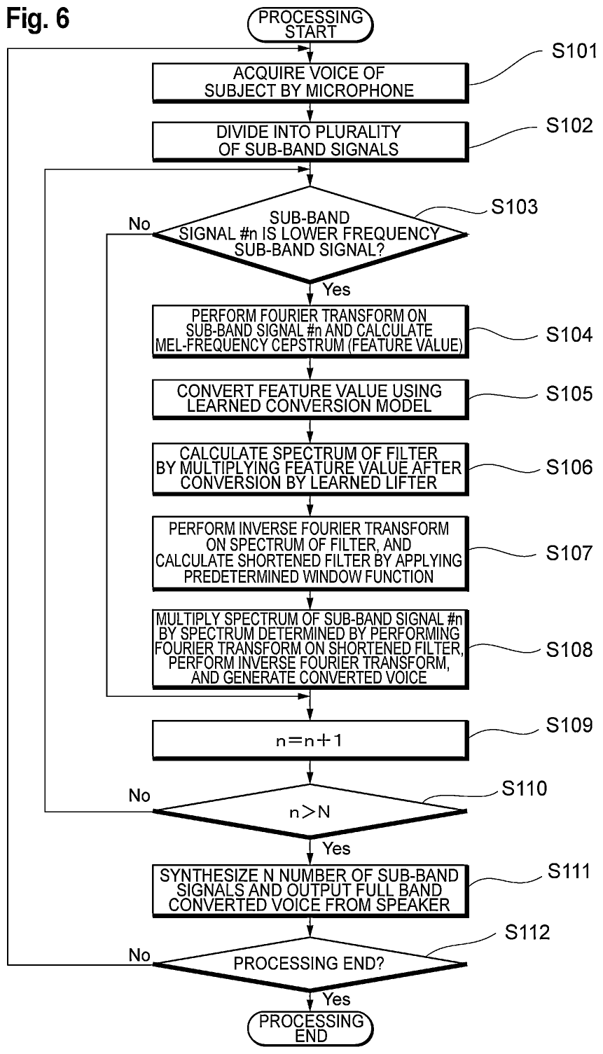

FIG. 6 is a flow chart of the voice conversion processing executed by the voice conversion apparatus 10 according to the present embodiment. First the voice conversion apparatus 10 acquires a voice of a subject using a microphone 20 (S101).

The voice conversion apparatus 10 divides the signal of the voice of the subject (full band signal) acquired in S101 into a plurality of sub-band signals (S102). Further, the voice conversion apparatus 10 initializes the index n of the sub-band to a predetermined value (e.g. 1).

The voice conversion apparatus 10 determines whether the sub-band signal of the sub-band #n (sub-band signal #n) is a lower frequency band sub-band signal or not (S103). If the sub-band signal #n is not a lower frequency band sub-band signal (if this signal is a higher frequency band sub-band signal) (S103: No), this operation advances to S109, skipping steps S103 to S108.

If the sub-band signal #n is a lower frequency band sub-band signal (S103: Yes), the voice conversion apparatus 10 performs Fourier transform on this sub-band signal #n, and calculates the mel-frequency cepstrum (feature value) (S104), then the feature value is converted using the learned conversion model 13a (S105).

Further, the voice conversion apparatus 10 multiplies the feature value after conversion by the learned lifter 13b to calculate the spectrum of the filter (S106), performs inverse Fourier transform on the spectrum of the filter, and applies a predetermined window function thereto, whereby the shortened filter is calculated (S107).

Then the voice conversion apparatus 10 multiplies the spectrum of the sub-band signal #n by the spectrum determined by performing Fourier transform on the shortened filter, and performs inverse Fourier transform thereon, so as to generate the converted voice of the sub-band signal #n (S108).

The voice conversion apparatus 10 counts the index n of the sub-band (S109), and determines whether the counted n is larger than the total number N of the sub-bands (S110). If the counted n is the total number N of the sub-bands or less (S110: No), this operation returns to S103.

If n counted in S109 is larger than the total number of sub-bands (S110: Yes), the voice conversion apparatus 10 generates a full band converted voice by synthesizing N number of sub-band signals, and outputs the generated full band converted voice from the speaker (S111).

In the case where the voice conversion processing is not ended (S112: No), the voice conversion apparatus 10 executes the processing steps S101 to S111 again. In the case where the voice conversion processing is ended (S112: Yes), on the other hand, the voice conversion apparatus 10 ends the processing.

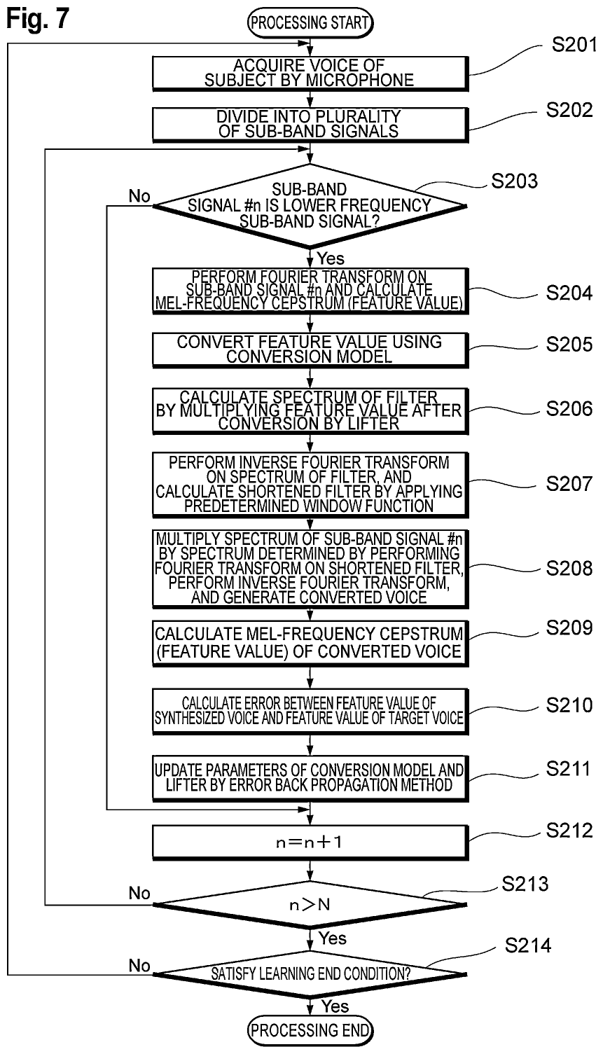

FIG. 7 is a flow chart of the learning processing executed by the voice conversion apparatus 10 according to the present embodiment. First the voice conversion apparatus 10 acquires a voice of a subject using the microphone 20 (S201). The voice conversion apparatus 10 may acquire a signal of a voice recorded in advance.

The voice conversion apparatus 10 divides the signal of the voice of the subject (full band signal) acquired in S201 into a plurality of sub-band signals (S202). Further, the voice conversion apparatus 10 initializes the index n of the sub-band to a predetermined value (e.g. 1).

The voice conversion apparatus 10 determines whether the sub-band signal of the sub-band #n (sub-band signal #n) is a lower frequency band sub-band signal (S203). If the sub-band signal #n is not a lower frequency band sub-band signal (if this signal is a higher frequency band sub-band signal) (S203: No), this operation advances to S212, skipping steps S204 to S111.

If the sub-band signal #n is a lower frequency band sub-band signal (S203: Yes), the voice conversion apparatus 10 performs Fourier transform on the signal of the voice of the subject, calculates the mel-frequency cepstrum (feature value) (S204), then converts the feature value using the conversion model 13a which is in the learning step (S205).

Further, the voice conversion apparatus 10 multiplies the feature value after conversion by the lifter 13b which is in the learning step, to calculate the spectrum of the filter (S206), performs inverse Fourier transform on the spectrum of the filter, and applies a predetermined window function thereto, whereby the shortened filter is calculated (S207).

Then the voice conversion apparatus 10 multiplies the spectrum of the sub-band signal #n by the spectrum determined by performing Fourier transform on the shortened filter to perform inverse Fourier transform, so as to generate the converted voice of the sub-band signal #n (S208).

Then the voice conversion apparatus 10 calculates the mel-frequency cepstrum (feature value) of the converted voice of the sub-band signal #n (S209), and calculates errors between the feature value of the synthesized voice and the feature value of the target voice (S210). Then the voice conversion apparatus 10 updates the parameters of the conversion model 13a and the lifter 13b by the error back propagation method (S211).

The voice conversion apparatus 10 counts the index n of the sub-band (S212), and determines whether the counted n is larger than the total number N of a sub-band (S213). If the counted n is the total number N of the sub-bands or less (S213: No), this operation returns to S203. If then counted in S212 is larger than the total number N of sub-bands (S213: Yes), the voice conversion apparatus 10 determines whether the learning end condition is satisfied (S214).

If the learning end condition is not satisfied (S214: No), the voice conversion apparatus 10 executes the processing steps S201 to S213 again. If the learning end condition is satisfied (S214: Yes), on the other hand, the voice conversion apparatus 10 ends the processing. The learning end condition may be “an error between the feature value of the synthesized voice and the feature value of the target voice is a predetermined value or less”, or “a number of epochs of the learning processing reached a predetermined number of times”, for example.

As described above, according to the voice conversion apparatus 10 of the present embodiment, only one or more lower frequency sub-band signals, out of the plurality of sub-band signals generated by dividing the full band signal of the voice of the subject, are converted, whereby the influence of random fluctuation in the higher frequency band can be reduced, and the calculation volume due to conversion can be reduced. Therefor even in wideband, voice conversion based on the differential spectrum method, which is capable of implementing both high voice quality and real-time performance, can be performed.

The above described embodiments are for assisting in understanding of the present invention, and are not intended to limit an interpretation of the present invention. Each composing element, disposition, material, condition, shape, size and the like of the embodiments are not limited to the described examples, but may be properly changed. Composing elements described in different embodiments may be partially replaced or combined with each other.

### REFERENCE SIGNS LIST

10 Voice conversion apparatus
10a CPU
10b RAM
10c ROM
10d Communication unit
10e Input unit
10f Display unit
11 Acquiring unit
12 Dividing unit
13 Filter calculating unit
13a Conversion model
13b Lifter
14 Shortened filter calculating unit
15 Generating unit
16 Synthesizing unit
17 Learning unit
20 Microphone
30 Speaker

1. A voice conversion apparatus comprising:
an acquiring unit configured to acquire a signal of a voice of a subject;
a dividing unit configured to divide the signal into sub-band signals corresponding to a plurality of frequency bands;
a converting unit configured to convert one or a plurality of sub-band signals corresponding to one or a plurality of lower frequency bands, out of the sub-band signals corresponding to the plurality of frequency bands; and
a synthesizing unit configured to generate a synthesized voice by synthesizing the one or plurality of sub-band signals after conversion and a remaining sub-band signal that is not converted.

2. The voice conversion apparatus according to claim 1, wherein
a sampling frequency of the signal is 44.1 kHz or more, and
the one or plurality of sub-band signals corresponding to the one or plurality of lower frequency bands include at least sub-band signals corresponding to 2 kHz to 4 kHz frequency bands.

3. The voice conversion apparatus according to claim 1 or 2, wherein
the converting unit further comprises:
a filter calculating unit configured to calculate a spectrum of a filter by converting a feature value indicating a tone of voice of the one or plurality of sub-band signals corresponding to the one or plurality of lower frequency bands using a learned conversion model, and multiplying the feature value after conversion by a learned lifter;
a shortened filter calculating unit configured to calculate a shortened filter by performing inverse Fourier transform on the spectrum of the filter, and applying a predetermined window function thereto; and
a generating unit configured to generate a converted voice of the one or plurality of sub-band signals corresponding to the one or plurality of lower frequency bands by multiplying the spectrum of the signal by the spectrum determined by performing Fourier transform on the shortened filter, and performing inverse transform thereon.

4. The voice conversion apparatus according to claim 3, further comprising
a learning unit configured to calculate a feature value indicating a tone of the converted voice by multiplying the spectrum of the one or plurality of sub-band signals corresponding to the one or plurality of lower frequency bands by the spectrum determined by performing Fourier transform on the shortened filter, updating a parameter of the conversion model and the lifter so as to minimize an error between the feature value and a feature value indicating a tone of a target voice, and generating the learned conversion model and the learned lifter.

5. The voice conversion apparatus according to claim 4, wherein
the conversion model is constructed by a neural network, and
the learning unit updates the parameter by an error back propagation method, and generates the learned conversion model and the learned lifter.

6. A voice conversion method executed by a processor included in a voice conversion apparatus, comprising steps of:
acquiring a signal of a voice of a subject;
dividing the signal into sub-band signals corresponding to a plurality of frequency bands;
converting one or a plurality of sub-band signals corresponding to one or a plurality of lower frequency bands, out of the sub-band signals corresponding to the plurality of frequency bands; and
generating a synthesized voice by synthesizing the one or plurality of sub-band signals after the conversion and a remaining sub-band signal that is not converted.

7. A voice conversion program that causes a processor included in the voice conversion apparatus to function as:
an acquiring unit configured to acquire a signal of a voice of a subject;
a dividing unit configured to divide the signal into sub-band signals corresponding to a plurality of frequency bands;
a converting unit configured to convert one or a plurality of sub-band signals corresponding to one or a plurality of lower frequency bands, out of the sub-band signals corresponding to the plurality of frequency bands; and
a synthesizing unit configured to generate a synthesized voice by synthesizing the one or plurality of sub-band signals after conversion and a remaining sub-band signal that is not converted.
